(19) United States
(12) Patent Application Publication
(10) Pub. No.: US 2003/0135453 A1
(43) Pub. Date: Jul. 17, 2003

(54) Transaction dispute management system and method

(76) Inventors: Brian Caulfield, Dublin (IE); William O'Connor, Dublin (IE)

Correspondence Address: JACOBSON HOLMAN PLLC, 400 SEVENTH STREET N.W., SUITE 600, WASHINGTON, DC, 20004, US

(21) Appl. No.: 10/322,479

(22) Filed: Dec. 19, 2002

Related U.S. Application Data
(63) Continuation of application No. PCT/IE00/00080, filed on Jun. 22, 2000.

(51) Int. Cl. G06F 17/60

(52) U.S. Cl. 705/38

(57) ABSTRACT

A system (1) receives data for a transaction dispute (12) and applies rules (13) to determine a recommended action. These rules involve processing a list of possible recommended actions in sequence until a match is found. The probability values are used for matching most instances, and a final recommended action in the list is selected by default. A decision tree (12) may be executed to progress a dispute. Each node has one or more parameter values, each parameter value directing retrieval of an answer using a particular mechanism. Each answer for a node is automatically written to a trace log. As execution progresses through the nodes, the trace log is built up. The trace log is used for execution of rules associated with an end node (53, 54, 56, 58, 61, 62, 63). The end nodes provides an output instruction for an action module (20).

### INTRODUCTION

1. Field of the Invention

The invention relates to control and resolution of dispute cases arising from transactions in any environment such as the credit card industry.

2. Prior Art Discussion

In the example of credit card transactions, processing of such transactions is more complex than appears to many consumers. A single transaction such as purchase of an item in a retail outlet involves interaction between cardholder, merchant, acquirer, credit card company, and issuer systems. A certain proportion of transactions (typically 0.2% of retail transactions and significantly more Internet transactions) give rise to disputes, which in turn may give rise to “chargebacks” in which the consumer is refunded. The handling of such disputes is quite complex because of both the complexity of transaction logic and of the relationships between the parties involved. Heretofore, this has required a large overhead because of time-consuming input by skilled administrative personnel, and the invention is directed towards addressing this problem.

### SUMMARY OF THE INVENTION

According to the invention there is provided a transaction dispute management system comprising:

means for receiving dispute data from a transaction processing system;

a recommended action rule processing means for determining a recommended action in response to the received dispute data;

a decision tree execution means for automatically executing a decision tree selected according to a recommended action, said decision tree execution being for determining an instruction for an action; and

a plurality of dispute resolution action modules each comprising means for automatically performing an action in response to said input instruction and for generating an output indicating the action performed.

In one embodiment, the decision tree execution means comprises means for determining a parameter value associated with each successive node of the decision tree, each parameter value indicating the manner in which the associated node is to be executed.

In one embodiment, the parameter value indicates if an answer is to be retrieved from a database, if a user is to be prompted to input an answer, or if rules are to be executed to determine an answer.

In a further embodiment, there are a plurality of parameter values associated with at least some nodes, and the decision tree execution means comprises means for obtaining an answer for each parameter value for each such node.

In one embodiment, a parameter value includes a database table address for a table fetch to retrieve an answer.

In a further embodiment, a parameter value includes an address for a database table of user questions to prompt input of an answer.

In one embodiment, the rules for determining an answer are goal-driven inferencing rules.

In a further embodiment, the decision tree execution means comprises means for capturing each answer of each node in a trace log.

In a further embodiment, the decision tree execution means comprises means for using the trace log as an input to a rule set associated with an end node to determine the decision tree output.

In one embodiment, the recommended action rule processing means comprises means for testing compliance with possible recommended actions of a list selected from a plurality of lists.

Preferably, the recommended action rule processing means comprises means for ceasing testing when a possible recommended action tests positive.

In one embodiment, the tests involve matching conditions associated with the recommended action.

In a further embodiment, the recommended action processing means comprises means for determining a positive test result if a probability value exceeds a threshold.

In one embodiment, the recommended action rule processing means comprises means for selecting a final recommended action in the list if processing reaches that recommended action.

In a further embodiment, the system comprises a rule processing means for processing a recommended action without use of a decision tree.

In another embodiment, said rule processing means comprises means for performing actions leading to closure of a dispute.

In another embodiment, the system further comprises means for dynamically updating decision trees to reflect changes in prescribed dispute-handling requirements.

According to another aspect, the invention provides a transaction dispute management method implemented by a transaction dispute management system linked to a transaction processing system, the method comprising the steps of:

receiving dispute data from the transaction processing system;

determining a recommended action in response to the received dispute data and according to stored rules;

selecting a stored decision tree according to the determined recommended action;

executing the decision tree to determine an instruction for an action; and

executing a dispute resolution action module to perform an action in response to said instruction and to generate an output indicating the action performed.

### DETAILED DESCRIPTION OF THE INVENTION

### BRIEF DESCRIPTION OF DRAWINGS

The invention will be more clearly understood from the following description of some embodiments thereof, given by way of example only with reference to the accompanying drawings in which:

FIG. 1 is a schematic representation of interaction of a system of the invention with users and other systems;

FIGS. 2 and 3 are flow diagrams illustrating operation of the system; and

FIG. 4 is an example of a simple decision tree.

### DETAILED DESCRIPTION OF THE INVENTION

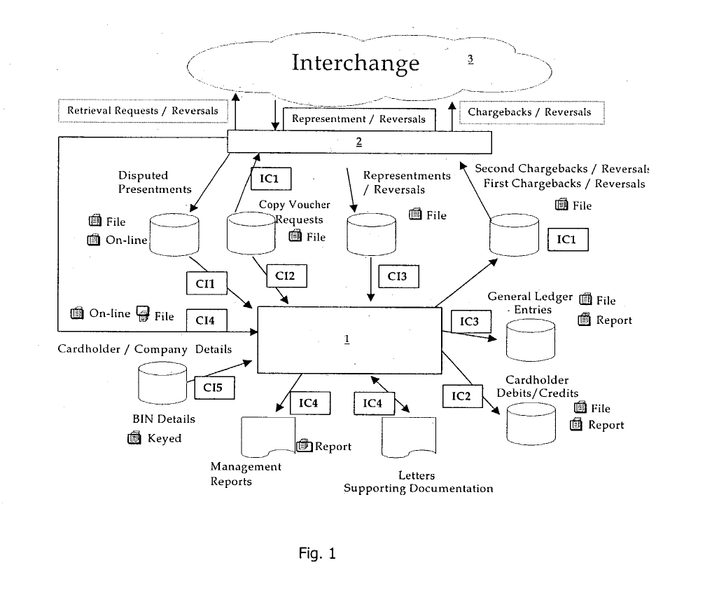

Referring to FIG. 1 a system 1 of the invention interfaces with a card management system 2, with an interchange system 3, and with users in the manner illustrated. The system 1 is operated by a card issuer company.

The system 1 processes the following input data from the card management system:

CI1: Disputed Presentments

CI2: Copy Voucher Requests

CI3: Representments/Reversals

CI4: Cardholder Data

CI5: Acquirer Data

The following table sets out the data in more detail.

| System | | |
|---|---|---|
| Interface | Interface | Description |
| CI1 | File | The file contains all presentments marked |
| | | as disputed in the card management |
| | | system. Usually the front-line support or |
| | | customer service department marks these |
| | | presentments as disputed based on |
| | | correspondence by phone, fax or e-mail |
| | | from the cardholder or company |
| | | representative. CI1 is created by the |
| | | previous night's host batch run, which |
| | | routes all ‘disputed’ presentments to the |
| | | CI1 file for processing. |
| | On-Line | There are two options with the on-line |
| | | presentment interface. |
| | | A Statement Browser is an application, |
| | | which provides the ability for users to |
| | | view all transactions appearing on a |
| | | cardholder's statements and to mark one |
| | | or more of these transactions as disputed. |
| | | Once marked as disputed, these |
| | | transactions are transferred to the system |
| | | 1 automatically. The Statement Browser |
| | | retrieves the presentment data using |
| | | either a database stored procedure or a |
| | | DLL. |
| | | A Retrieve Case function allows system |
| | | users to key a cardholder's account |
| | | number and acquirer reference number to |
| | | setup a disputed presentment real-time in |
| | | the system. A stored procedure or DLL |
| | | call is used to retrieve the transaction data |
| | | from the card management system or |
| | | transaction database based on the |
| | | cardholder's account number and |
| | | acquirer reference number. |
| CI2 | File | This file contains copy voucher requests |
| | | generated in the card management |
| | | system 2 by any combination of customer |
| | | service, fraud and chargeback personnel. |
| | | CI2 is created by the previous night's host |
| | | batch run which routes all copy voucher |
| | | requests to the CI2 file for processing. |
| | | This interface applies when a site does |
| | | not wish to avail of the copy voucher |
| | | request generation facility within the |
| | | system 1. |
| CI3 | File | The file contains representments and |
| | | representment reversals destined for the |
| | | Issuer. The CI3 file is created through the |
| | | card management system's routing of |
| | | incoming representments and |
| | | representment reversals from |
| | | interchange. This routing is conducted by |
| | | the previous night's host batch run. |
| CI4 | File | This file is created when the CI1 file is |
| | | generated. All cardholder/company data |
| | | pertaining to cardholders' accounts whose |
| | | transactions have been disputed (and are |
| | | contained in the CI1 file) can be extracted |
| | | by the previous night's host batch run into |
| | | a file of cardholder/company data. |
| | | Should the cardholder/company address |
| | | information change after it has been read |
| | | into the system, then the latest cardholder |
| | | data should appear in the CI4 file once the |
| | | address has changed. The system 1 will |
| | | then update the cardholder/company |
| | | address information in the system |
| | | database for that record. The format of |
| | | this input file can be site specific. |
| | | This data is used by the system 1 when |
| | | corresponding with the cardholder/ |
| | | company throughout the chargeback |
| | | life cycle. |
| | On-Line | The system 1 enables the generation and |
| | | maintenance of cardholder information |
| | | through an on-line interface. This |
| | | interface can be achieved using a |
| | | database stored procedure or a DLL. The |
| | | DLL version of the interface relies on the |
| | | Issuer to provide the DLL, which will |
| | | accept a cardholder's account number, as |
| | | input and return the cardholder's |
| | | correspondence address as output. |
| CI5 | Keyed | This data is currently keyed on-line. Once |
| | | acquirer address details have been |
| | | entered for a given transaction, the data is |
| | | present in the system 1 for all subsequent |
| | | transactions pertaining to the same |
| | | acquirer. |

The system 1 generates the following output data as shown in FIG. 1.

IC1: Retrieval Requests/Reversals/Chargebacks/Reversals

IC2: Cardholder Adjustments

IC3: General Ledger Adjustments

IC4: Letters/Documentation

| ICS Interface | Interface Option | Description |
|---|---|---|
| IC1 | File | The file is generated by the system 1 |
| | | during an End of Day batch run. The |
| | | file contains all the retrieval requests |
| | | and retrieval request reversals |
| | | generated on that business day. The |
| | | file also contains chargebacks (both 1^{st} |
| | | and 2^{nd}) and chargeback reversals |
| | | (both 1^{st} and 2^{nd}) generated on that |
| | | business day. In addition, automatic |
| | | chargebacks are also compiled and |
| | | routed to the IC1 file. |
| IC2 | File | The file is generated during the End of |
| | | Day batch run. This file contains all |
| | | cardholder credit and debit |
| | | adjustments created manually by the |
| | | users or automatically by the system 1 |
| | | during that business day. |
| | Report | This report can be generated using a |
| | | Supervisor application of the system 1. |
| | | The report lists all cardholder credit |
| | | and debit adjustments created |
| | | manually by the users or automatically |
| | | by the system 1 during that business |
| | | day. |
| IC3 | File | The file is generated during the End of |
| | | Day batch run. This file contains all |
| | | credit and debit general ledger |
| | | adjustments created manually by the |
| | | users or automatically by ICS during |
| | | that business day. |
| | Report | This report can be generated using the |
| | | Supervisor application. The report lists |
| | | all credit and debit general ledger |
| | | adjustments created manually by the |
| | | users or automatically during that |
| | | business day. |
| IC4 | Letter/Report | Letters are printed as they are |
| | | generated or can be printed in batch |
| | | via the Print Queue. |

The above inputs and outputs arise from processing of transaction disputes. A cardholder or a company card representative can initiate a dispute after issuance of a card statement. The customer service department is responsible for marking the relevant transaction as disputed in the card management system.

Also, disputes may be raised by other departments such as fraud, debt recovery, collections, and closed accounts. The issuer often decides to credit the cardholder until further investigation has taken place.

The issuer has a number of choices with regard to processing the dispute.

The issuer may decide to:

a) generate a retrieval request (if the sales voucher will help to confirm whether the dispute is valid)

b) generate a chargeback (if the dispute appears to be genuine and a sales voucher is not required as part of the supporting documentation)

c) close the case (if the dispute is invalid)

d) generate a collections letter (if the Issuer is aware that there is no chargeback right but wants to attempt to retrieve the funds on behalf of the cardholder)

e) write off the transaction (if the dispute is valid but the Issuer is entirely at fault and therefore has no possibility of recovering money through chargeback or collections)

f) debit the cardholder (if the cardholder was initially credited when the dispute was raised and if they subsequently recognise the transaction)

Chargeback Clearing/Settlement

If the Issuer generates a chargeback or retrieval request, then these records are collated into a file by a batch process, which is usually run at the end of the business day. This file is then sent to interchange. Interchange will validate the records on the file and will ‘settle’ with the Issuer for all the valid financial records in the file. Retrieval requests/reversals are non-financial records and chargebacks/reversals are financial records. Interchange will also route the chargebacks and retrieval requests to the relevant acquirer for processing.

Retrieval Request Fulfillment/Non-Fulfillment

Once the acquirer receives the retrieval request, the following actions may be taken:

a) retrieve a copy of the voucher (internally in the voucher library or from the merchant) and fulfil it to the issuer within the required timeframe.

b) issue a non-fulfillment record to the Issuer indicating the reason why the voucher cannot be supplied.

Once the Issuer receives the fulfillment or non-fulfillment, the options to generate a chargeback, close the case or generate a collections letter are available as actions.

Representment/Second Presentment

Once the acquirer receives the chargeback and determines that the chargeback reason can be refuted, the acquirer can issue a representment/second presentment. Other actions available to the acquirer are:

a) accept the chargeback (if the chargeback is valid and the acquirer has no further dispute rights)

b) represent the chargeback (if the acquirer can remedy the chargeback by providing additional information which disputes the chargeback reason)

c) debit the merchant (if the chargeback is valid and the dispute was initiated due to merchant error)

Representment Clearing/Settlement

If the Acquirer generates a representment, then these records are sent to Interchange. Interchange will validate the records on the file and will ‘settle’ with the Acquirer for all the valid representments in the file. Interchange will also route the representments to the relevant Issuer for processing.

Assess Representment/Second Chargeback/Pre-Arbitration

Once the issuer receives the representment and analyses the reason the Acquirer represented the transaction, the following actions may be taken:

a) generate a second chargeback (if the representment is invalid). The Issuer may issue a second chargeback using a different chargeback reason than was used with the first chargeback.

b) issue a pre-arbitration letter ( if the representment is invalid and the Issuer has no further chargeback rights)

c) accept the representment (if the representment is valid but the cardholder continues to dispute the transaction)

d) debit the cardholder (if the representment is valid and remedies the cardholder's dispute)

Pre-Arbitration/Arbitration

Both the Issuer and Acquirer have arbitration rights once the chargeback stages in the chargeback lifecycle has expired and they still wish to dispute the transaction. The Issuer can issue a pre-arbitration letter where no second chargeback right exists (e.g. ATM transaction) or where a second representment was received. The pre-arbitration process adheres to strict deadlines and is aimed at resolving the dispute before it reaches the attention of the card schemes. However, if the Issuer and Acquirer cannot resolve the dispute through the pre-arbitration process, the arbitration court of the appropriate card scheme will make a ruling on the dispute and inform both parties (i.e. the Issuer and the Acquirer) of the ruling.

Collections

At any stage in the chargeback lifecycle, should the Issuer have no chargeback rights available e.g. if the transaction is out of time for chargeback for example, the Issuer can attempt to recover some or all of the funds through the Good Faith Collections process. This involves the Issuer sending a collections letter to the acquirer outlining the reason for dispute and requesting some or all of the funds to be reimbursed by the acquirer. The acquirer may decide to accept the collections request and reimburse the Issuer or reject the collections request.

As is clear from the above, the system 1 performs actions such as processing a chargeback through its lifecycle, performing a retrieval, generating a collections letter, or debiting a cardholder. The decision on what action to take is a complex one, depending on complex business logic and the particular circumstances of the transactions.

Operation of the System

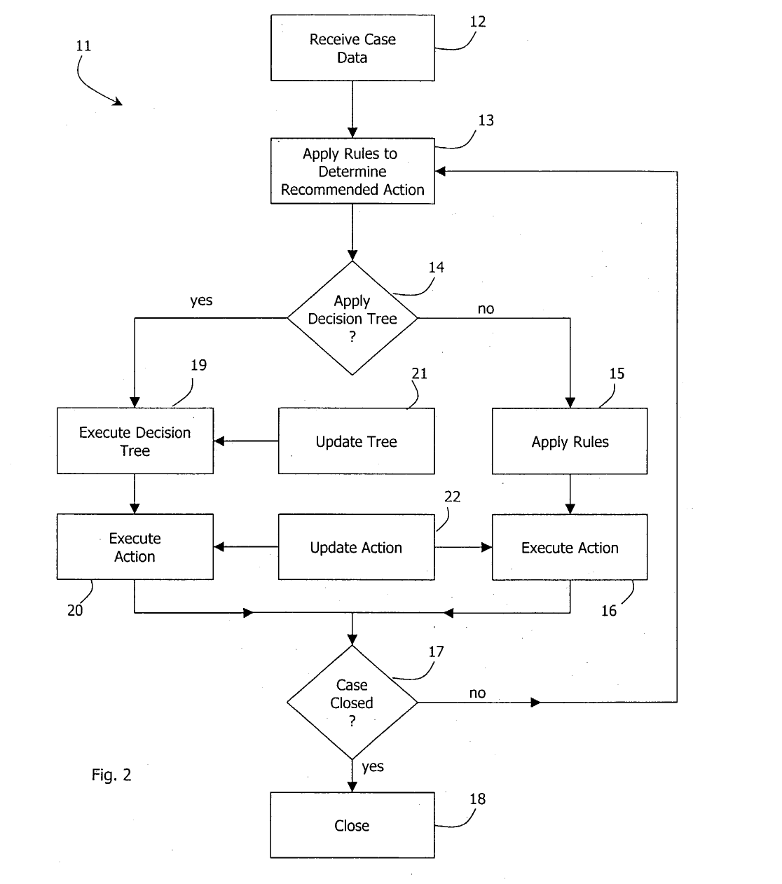

Referring to FIG. 2 a method 11 performed by the system 1 is illustrated. In step 12 case data is received, for example, from the card management system 2 in a batch or on-line transfer or from a user keying in the data. In step 13 rules are applied to determine a recommended action. These rules use an indication of the lifecycle stage in the received data, and perform tests for possible recommended actions (RAs) in turn. The RA order is probability governed by the lifecycle stage indicated in the received data. Each test involves attempting to match conditions using IF/THEN/ELSE coding. An example of a simple condition is an upper threshold amount for a transaction. Each list has a last or final default RA which is chosen if the testing reaches that RA by not achieving a match for a previous RA in the list. Matching of an RA need not necessarily involve complete satisfaction of the test conditions, as the acceptance of an RA may involve achieving conformity above a probability threshold such as 80%. An example is where two RAs comprising 14 of 16 conditions are satisfied but one RA is chosen over the other based on the weighting factor of the satisfied conditions.

The selected RA provides an indication in the relevant RA database record of whether to use a decision tree for further processing of the dispute. Decision trees for further processing are governed by compliance with prescribed official requirements. An example is the set of dispute-handling chargeback rules developed by the major credit card companies.

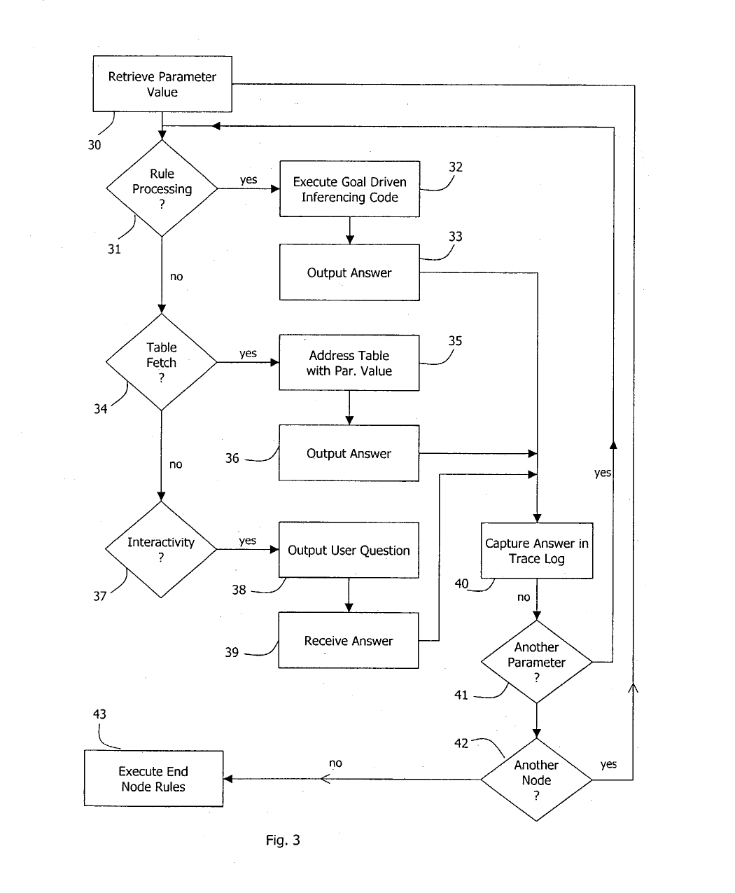

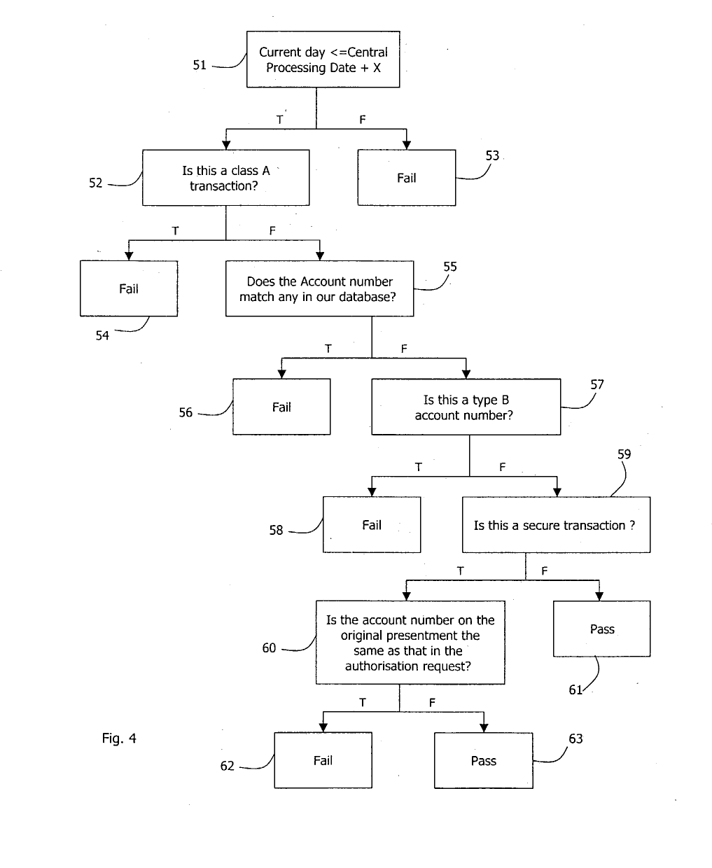

If decision tree processing is not required, general accounting and business rules are applied in step 15. This may simply involve generating messages for interested parties to execute an action in step 16 to close the dispute case. The latter decision is indicated by the decision step 17. Where the case is not to be closed, the process loops back to step 13. Closure of the case is performed in step 18.

Where decision tree processing is required, a particular decision tree associated with the selected RA is executed in step 19. This is described in detail below with reference to FIGS. 3 and 4.

The output of the decision tree processing step 19 is an instruction for activating a module to implement a prescribed action such as an interfacing action IC1, IC2, IC3, or IC4 described above. As for the alternative branch through steps 15 and 16, the case may be closed or it may loop back to step 13.

As shown by the step 21, the changes in the prescribed requirements are dynamically incorporated by updating the relevant decision trees. This involves the following steps.

1) analysis of a new rule set

2) determination of the impact of the changes contained in the new rule set on the multiplicity of existing decision trees

3) amendment of existing decision trees and generation of new decision trees as appropriate application of relevant changes to System 1.

A step 22 involves updating prescribed actions by changing a relevant dispute resolution module. This is prompted by a change in the workflow governed by business rules or policies.

Referring to FIGS. 3 and 4, step 19 is described in more detail. In step 30 a parameter value for the first (and top) node of the tree is retrieved. The system processor then proceeds to use one of three mechanisms for obtaining an answer, and the required mechanism is indicated in the parameter value. The fist method is rule processing as indicated by the decision step 31. This involves executing goal-driven inferencing code in step 32 to generate an answer which is outputted in step 33. The second mechanism, as indicated by the decision step 34, is to address a database table in step 35 with an address included in the parameter value. This results in output of an answer in step 36. The third mechanism, as indicated by the decision step 37, is to interactively communicate with an authorised user by outputting a question in step 38 and receiving an answer in step 39.

After an answer has been obtained, the processor in step 40 captures an answer for that parameter in the trace log. It then loops back in step 41 for each additional parameter associated with the particular node of the decision tree. There may be up to three parameters for each node, one associated with each mechanism. The answer may, for example, be to proceed with a chargeback process if the current time is within the allowed time limit.

The following is an example of a trace log:

```
--invoking US_Non_TE_Codes_May99
  --executing agenda
  --evaluating Reason_Code_31_US_May99
  --Reason_Code_31_US_May99 failed
  --evaluating Reason_Code_41_US_May99
--Reason_Code_41_US_May99 succeeded
--invoking Reason_Code_41_US_May99
--executing agenda
--evaluating Sub_41_SecondCB_US_May99
--Sub_41_SecondCB_US_May99 failed
--evaluating Sub_41_State_US_May99
--Sub_41_State_US_May99 succeeded
--invoking Sub_41_State_US_May99
--executing agenda
--determining recur_trans
  --executing facts
  --executing get_boolean
  --executing ask_boolean
  --clear (Bool_Pa)
  --sending delete_answers to class CBAnswer
  -->>CBAnswer(CBAnswer_00019) .DATE_TIME is 11-May-00
  -->>CBAnswer(CBAnswer_00019) .USER_ID is ics_client
  -->>CBAnswer(CBAnswer_00019) .USAGE is 1
  -->>CBAnswer(CBAnswer_00019) .QUESTION is 157
  -->>CBAnswer(CBAnswer_00019) .ANSWER is T
  -->>Bool_Pa is Yes
  --get_boolean completed
  -->>recur trans is Yes
  --facts completed
--recur_trans completed
--determining ATM_trans
  --executing facts
  -->>ATM_trans is No
  --facts completed
--ATM_trans completed
```

As indicated by the decision step 42, steps 30 to 41 are repeated for each additional node of the decision tree. When all nodes in a route to an end node have been processed, a set of rules associated with the end node are executed in step 43 using the trace log. These rules generate a positive or negative output together with text indicating the reasoning behind the output and other key transaction information.

Referring in particular to FIG. 4, a decision tree 50 is shown. A top node 51 has a parameter calling a rule concerning the current day, as illustrated. A fail answer outputted in step 33 brings the processing to an end node 53. The trace log in this case provides the data for a text statement indicating the reasoning behind the negative output. A True output of the rule brings the processor to a node 52 in which a parameter value indicates a database table fetch 35 to determine the class of transaction. A class A value causes termination of step 19 with an end node 54. A different class brings processing to a node 55, which has parameter values causing a fetch 35 and subsequently an interactive step 38 if the fetch fails. An end node 56 is executed if the account number does not match. Alternatively, a node 57 is executed in a manner similar to node 55 (involving both a fetch 35 and possibly also interactivity 38). The next node is either an end node 58 or node 59 having a parameter indicating rule processing 32 to provide an output leading to either an end node 61 or a node 60 involving a fetch 35 and interactivity 38 if the fetch fails. The next nodes 62 and 63 are both end nodes.

It will be appreciated that the invention provides for very highly automated processing of transaction disputes in a manner which minimises user inputs required. The recommended action rules processing means ensures that a recommended action is selected, even without complete matching of test conditions by selection of the last action from the appropriate list. In most instances, there will be no need to select the last (default) recommended action as an earlier action may be chosen according to probabilities for matching of conditions. The recommended action can select operation of a decision tree execution means which generates an instruction for a dispute resolution action module in a very effective manner. There is comprehensive gathering of the answers which are required using one or more of a number of techniques to ensure optimum versatility. These answers form a comprehensive input for rule processing at an end node to help ensure that the correct action module instruction is generated. Also, the use of the decision tree and of action modules for the prescribed rules and actions respectively allow the system to be updated in a dynamic and simple manner to reflect changes in these rules and actions. The rule processing means for steps 15, 16, and 20 allow an alternative to RA processing where this is appropriate. A further major advantage is the extent of integration with other systems, as set out with reference to FIG. 1.

The invention is not limited to the embodiments described but may be varied in construction and detail within the scope of the claims.

1. A transaction dispute management system comprising:
means for receiving dispute data from a transaction processing system;
a recommended action rule processing means for determining a recommended action in response to the received dispute data;
a decision tree execution means for automatically executing a decision tree selected according to a recommended action, said decision tree execution being for determining an instruction for an action; and
a plurality of dispute resolution action modules each comprising means for automatically performing an action in response to said input instruction and for generating an output indicating the action performed.

2. A transaction dispute management system as claimed in claim 1, wherein the decision tree execution means comprises means for determining a parameter value associated with each successive node of the decision tree, each parameter value indicating the manner in which the associated node is to be executed.

3. A transaction dispute management system as claimed in claim 1, wherein the decision tree execution means comprises means for determining a parameter value associated with each successive node of the decision tree, each parameter value indicating the manner in which the associated node is to be executed; and wherein the parameter value indicates if an answer is to be retrieved from a database, if a user is to be prompted to input an answer, or if rules are to be executed to determine an answer.

4. A transaction dispute management system as claimed in claim 3, wherein there are a plurality of parameter values associated with at least some nodes, and the decision tree execution means comprises means for obtaining an answer for each parameter value for each such node.

5. A transaction dispute management system as claimed in claim 3, wherein a parameter value includes a database table address for a table fetch to retrieve an answer.

6. A transaction dispute management system as claimed in claim 3, wherein a parameter value includes an address for a database table of user questions to prompt input of an answer.

7. A transaction dispute management system as claimed in claim 3, wherein the rules for determining an answer are goal-driven inferencing rules.

8. A transaction dispute management system as claimed in claim 1, wherein the decision tree execution means comprises means for capturing each answer of each node in a trace log.

9. A transaction dispute management system as claimed in claim 1 wherein the decision tree execution means comprises means for capturing each answer of each node in a trace log; and wherein the decision tree execution means comprises means for using the trace log as an input to a rule set associated with an end node to determine the decision tree output.

10. A transaction dispute management system as claimed in claim 1, wherein the recommended action rule processing means comprises means for testing compliance with possible recommended actions of a list selected from a plurality of lists.

11. A transaction dispute management system as claimed in claim 1 wherein the recommended action rule processing means comprises means for testing compliance with possible recommended actions of a list selected from a plurality of lists; and wherein the recommended action rule processing means comprises means for ceasing testing when a possible recommended action tests positive.

12. A transaction dispute management system as claimed in claim 11, wherein the tests comprise matching conditions associated with the recommended action.

13. A transaction dispute management system as claimed in claim 1, wherein the recommended action rule processing means comprises means for testing compliance with possible recommended actions of a list selected from a plurality of lists; and wherein the recommended action processing means comprises means for determining a positive test result if a probability value exceeds a threshold.

14. A transaction dispute management system as claimed in claim 1, wherein the recommended action rule processing means comprises means for testing compliance with possible recommended actions of a list selected from a plurality of lists; and wherein the recommended action rule processing means comprises means for selecting a final recommended action in the list if processing reaches that recommended action.

15. A transaction dispute management system as claimed in claim 1, wherein the system comprises a rule processing means for processing a recommended action without use of a decision tree.

16. A transaction dispute management system as claimed in claim 1, wherein the system comprises a rule processing means for processing a recommended action without use of a decision tree; and wherein said rule processing means comprises means for performing actions leading to closure of a dispute.

17. A transaction dispute management system as claimed in claim 1, wherein the system further comprises means for dynamically updating decision trees to reflect changes in prescribed dispute handling requirements.

18. A computer program product comprising software code portions for providing a transaction dispute management system as claimed in any preceding claim when loaded on a digital computer.

19. A transaction dispute management method implemented by a transaction dispute management system linked to a transaction processing system, the method comprising the steps of:
receiving dispute data from the transaction processing system;
determining a recommended action in response to the received dispute data and according to stored rules;
selecting a stored decision tree according to the determined recommended action;
executing the decision tree to determine an instruction for an action; and
executing a dispute resolution action module to perform an action in response to said instruction and to generate an output indicating the action performed.
